(19) United States
(12) Patent Application Publication
(10) Pub. No.: US 2009/0257712 A1
(43) Pub. Date: Oct. 15, 2009

(54) WAVEGUIDE WITH ASYMMETRIC OUTCOUPLING

(75) Inventors: Ramon Pascal Van Gorkom, Eindhoven (NL); Marcelllinus Petrus Carolus Michael Krijn, Eindhoven (NL); Anthonie Hendrik Bergman, Eindhoven (NL); Michel Cornelius Josephus Marie Vissenberg, Eindhoven (NL); Willem Lubertus Ijzerman, Eindhoven (NL); Willem Franciscus Johannes Hoogenstraaten, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/306,743

(22) PCT Filed: Jul. 5, 2007
(86) PCT No.: PCT/IB2007/052636

§ 371 Date: Dec. 29, 2008

(30) Foreign Application Priority Data
Jul. 10, 2006 (EP) 06116875.3

(51) Int. Cl. G02B 6/42

(52) U.S. Cl. 385/31

(57) ABSTRACT

A waveguide (1), arranged to guide light from at least one light source (3), comprising an outcoupling structure (4) adapted to enable outcoupling of said light from said waveguide in a general outcoupling direction, and at least one guiding edge (5) adapted to contain said light in said waveguide by reflecting said light on its way towards said outcoupling structure, wherein the outcoupling structure comprises an asymmetrically diffusing layer (6; 7). Such asymmetric diffusion improves the color mixing, and removes or limits the occurrence of color bands or intensity bands, while limiting the divergence in the direction where no color mixing or intensity variation problems exist.

### TECHNICAL FIELD

The present invention relates to a waveguide, arranged to guide light from at least one light source, the waveguide comprising at least one guiding edge adapted to contain the light in the waveguide, and an extraction edge adapted to enable extraction of the light from the waveguide.

The invention further relates to a lighting device comprising such a waveguide and a display device including such a lighting device.

### TECHNICAL BACKGROUND

There are several lighting applications in which light from at least one light source is coupled into a waveguide and emitted from one or several surfaces of the waveguide. In some applications, for example a backlight for a liquid-crystal display, light can be coupled out through a top surface of a large size planar waveguide. In other applications, light can be coupled out at one or several edges of the waveguide. By using a planar waveguide and coupling light out at at least one of its edges, several different types of lighting devices can be realized. One example of such a lighting device is a transparent lamp, which is formed by a number of planar waveguides. In the case of such a lamp, light can be extracted from selected portions of the lamp surface by forming the emitting edges of the waveguides as angled mirrors at the proper locations.

Suitable light sources for such lighting devices include light emitting diodes (LEDs). LEDs are generally narrow banded, and some processing of light emitted from a LED is typically required to produce white light. An energy efficient way of producing white light is to combine light emitted by light sources, such as LEDs, of suitable colors (typically red, green and blue) to form white light.

Such a combination of light from differently colored LEDs may take place in the waveguide and the intensity and spatial color distribution of mixed light emitted from the waveguide is generally rather uniform at the extraction edge(s) of the waveguide. Some distance away from this/these edge(s), however, variations in intensity and/or color are perceivable. Since the human eye is very sensitive to slight variations in color, a very good color mixing is required to produce uniform white light.

Also in the case of white or colored light emitted by a single light source and guided through a waveguide, insufficient spatial uniformity may be experienced, especially at some distance away from the extraction edge(s) of the waveguide.

One known method of improving spatial uniformity of light extracted from a waveguide is to diffuse the outcoupling edge of the waveguide. Through this method, an improved spatial uniformity may be achieved. However, the energy efficiency is decreased through back scattering of light and the extracted light may diverge more than is desirable.

There is thus a need for a more energy-efficient way of reducing spatial intensity and/or color variations perceived at some distance from the extraction edge(s) of a waveguide.

### OBJECT OF THE INVENTION

In view of the above-mentioned and other drawbacks of the prior art, an object of the present invention is to provide a more energy-efficient way of improving spatial uniformity of light emitted by a waveguide.

By “spatial uniformity” of light should here be understood uniformity of light in the space domain. Spatial uniformity includes uniformity in color and intensity. In fact, variations in color in a “white light” application may be equivalent to intensity variations in a monochrome application.

### SUMMARY OF THE INVENTION

According to a first aspect of the present invention, these and other objects are achieved through a waveguide comprising an extraction edge adapted to enable outcoupling of said light from said waveguide in a general outcoupling direction, at least one guiding edge adapted to contain said light in said waveguide by reflecting said light on its way towards said extraction edge, wherein extraction edge is provided with an asymmetrically diffusing layer.

By “diffusing” should here be understood that irregularities in the reflecting surface are in the order of the wavelength of the light, while the surface is still macroscopically flat.

By “asymmetrically diffusing” should be understood that the degree of diffusion is not the same in all planes. In particular, the diffusing layer can be adapted to diffuse light differently in two different (e.g. orthogonal) planes parallel to the general outcoupling direction.

The waveguide can be arranged to incouple and guide light from a plurality of light sources, and mix said light in at least one mixing plane. The diffusing layer can then be adapted to diffuse light more in this mixing plane than a plane normal to said mixing plane. Such asymmetric diffusion improves the color mixing, and removes or limits the occurrence of color bands or intensity bands, while limiting the divergence in the direction where no color mixing or intensity variation problems exist.

The outcoupling structure can be a transmissive surface, adapted to outcouple light through this surface, or be a reflective surface, adapted to outcouple light through the top and/or bottom surface of the waveguide, following a reflection in the reflective surface. The outcoupling structure may be configured in various ways—it may be flat, curved, prism-shaped, rounded, more or less diffuse etc.

In a case where light is outcoupled through the extraction edge, the diffusing layer can be a transparent diffusing layer.

In a case where light is outcoupled through a top or bottom surface after reflection in the extraction edge, the diffusing layer can be a diffusing mirror. A diffuse mirror can be formed, for example by applying a metallic coating to a diffusing guiding edge surface.

The waveguide is preferably a planar waveguide. A “planar waveguide” is here defined, as a waveguide having an extension essentially in one plane, i.e. the distance to the plane from any point of the waveguide is small compared to the dimensions of the waveguide in the plane. Alternatively, the waveguide is non-planar, which may be useful for specifically designed illuminaires.

Furthermore, the waveguide may be arranged to guide light from a plurality of light sources, for example emitting a plurality of different colors. A light guide according to this embodiment of the present invention will improve the color mixing of the light, and for example enable emission of white light created by differently colored LEDs, without color variations at a distance form the waveguide.

According to a second aspect of the invention, these and other objects are achieved by a lighting device comprising at least one light source and a waveguide according to the present invention.

Advantageously, this at least one light source may be at least one of side emitting and forward emitting (e.g. Lambertian) LEDs.

According to a third aspect of the invention, these and other objects are achieved by a display device comprising a display and a lighting device according to the present invention.

### BRIEF DESCRIPTION OF THE DRAWINGS

These and other aspects of the present invention will now be described in more detail, with reference to the appended drawings showing a currently preferred embodiment of the invention.

FIG. 1 is a perspective view of a waveguide according to an embodiment of the present invention;

FIG. 2 is an illustration of asymmetric diffusion;

FIGS. 3a-c schematically show examples of applications for a waveguide according to the present invention.

### DETAILED DESCRIPTION OF PREFERRED EMBODIMENTS

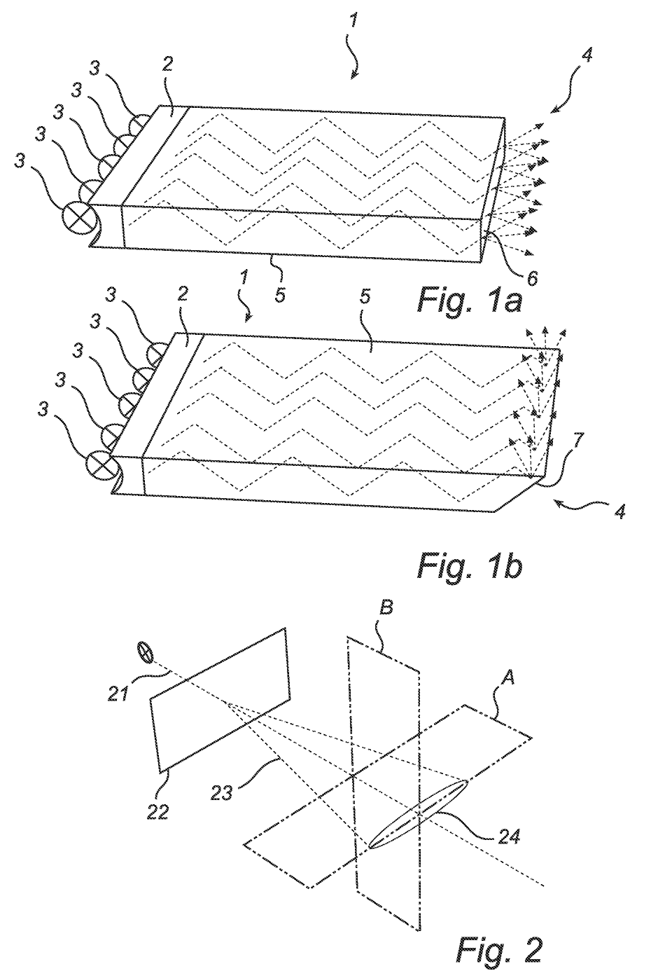

FIGS. 1a-b show a flat planar waveguide 1 comprising an incoupling structure 2 adapted to receive light from a plurality of light sources 3, e.g. LEDs, and an outcoupling structure 4, adapted to couple light out of the waveguide 1. Between the incoupling structure 2 and the outcoupling structure 4, light is retained in the waveguide 1 by guiding edges 5. The guiding edges 5 may rely upon total internal reflection (TIR), reflectors, or a combination of TIR and reflectors at the edges and/or top and/or bottom surfaces.

The waveguide can be formed of a slab of a single dielectric material or combinations of dielectric materials. Suitable dielectric materials include different transparent materials, such as various types of glass, poly-methyl methacrylate (PMMA) etc. The waveguide may also be air, at least partly enclosed by waveguide reflectors. The material of the waveguide is preferably selected such that the interface between the waveguide and the surrounding medium fulfills the conditions for total internal reflection for light of incident angles provided by the incoupling structure.

In FIG. 1a, the outcoupling structure 4 is formed by an edge 6 of the waveguide that is adapted to allow light to pass through it. In case of a TIR waveguide, this means that the edge 6 is adapted to remove the conditions for total internal reflections. For example, the edge 6 can be provided with structures that scatter the light, or comprise a diffusing layer.

In FIG. 1b, the outcoupling structure 4 is a reflecting surface 7, adapted to direct light towards one of the guiding edges, but with an angle of incidence such that the conditions for total internal reflection are no longer fulfilled, and the light will pass through the guiding edge 5.

According to an embodiment of the present invention, the outcoupling structure, e.g. the diffusing layer in FIG. 1a or the reflecting surface in FIG. 1b, is provided with an asymmetrically diffusing layer 8, 9.

In the case where light is outcoupled through the outcoupling structure, the asymmetrically diffusing layer is a transparent layer. Such a layer can be realized by various techniques, including, but not limited to, laminating a diffusing foil, or by roughing the surface in one direction using mechanical force, embossing the pattern while the waveguide is hot (and hence deformable), by using a laser to make the structure, or by lithographic definition.

In the case where light is reflected in the uncoupling structure (e.g. FIG. 1b), the asymmetrically diffusing layer can be an asymmetrically diffusing mirror, such as a reflector of anodized aluminum. Such reflectors are provided e.g. by the Alanod Company under the brand MIRO.

FIG. 2 illustrates the concept of asymmetrical diffusion. When a ray of light 21 passes an asymmetric diffusor 22, the light is diffused more in a first plane A than in a second plane B. As a result, the emerging beam 23 will have an elliptic cross section 24.

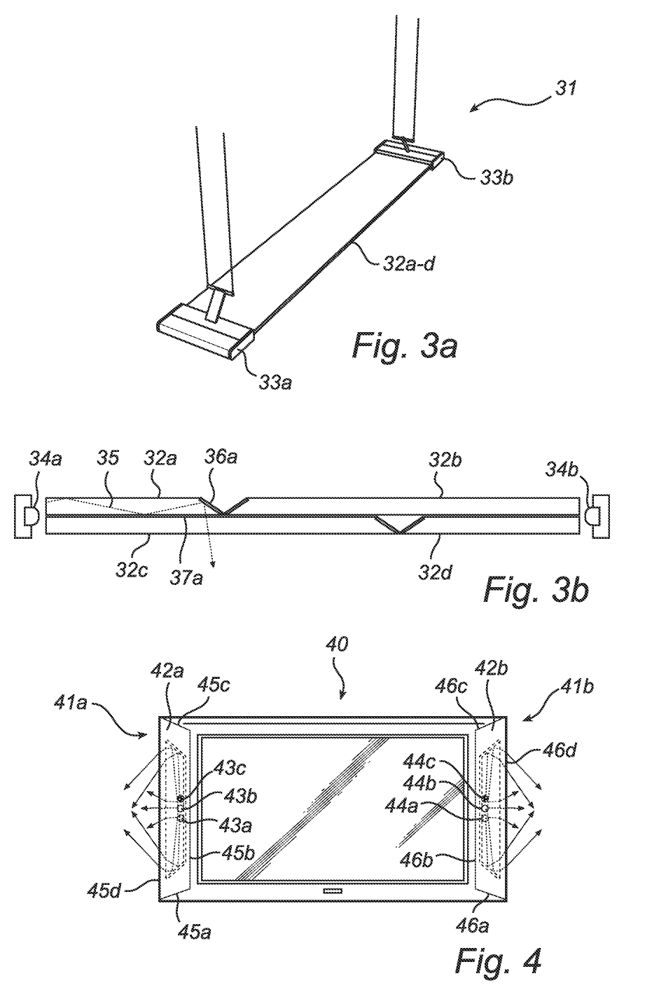

FIG. 3a illustrates, in a perspective view, a lighting device 31 in the form of a flat transparent lamp mainly constituted by a number of planar transparent waveguides 32a-d suspended between two holders 33a-b. In the holders, 1-D arrays of light-sources 34a-b, here in the form of Lambertian LEDs (see FIG. 3b), are contained.

With reference to FIG. 3b, light 35 from one of the light-source arrays 34a is coupled into one of the waveguides 32a, transported by the waveguide and, after reflection in a mirror 36a, coupled out of the waveguide 2a through the bottom surface 37a of the waveguide 32a in the vicinity of the mirror 36a. Light is, of course, guided through the remaining waveguides 32b-d in the same fashion. In the above example, four waveguides 32a-d are used. Of course, a larger number of waveguides could be used.

In FIG. 4, a second example of an application for a waveguide according to the invention is schematically shown. Here, two lighting devices 41a-b are integrated in a display device 40, here in the form of a flat TV-set. The purpose of the lighting devices 41a-b is to provide ambient lighting around the TV-set to thereby improve the viewing experience of a user. Each of the lighting devices 41a-b includes a waveguide 42a-b and three side-emitting LEDs 43a-c; 44a-c which are preferably red \textcircled{R} green (G) and blue (B). Each of the waveguides further has three guiding edges 45a-c; 46a-c and one transmissive, extraction edge 45d; 46d. During operation of these ambient lighting devices 41a-b, light from the colored light-sources 43a-c, 44a-c is transported and mixed in the waveguides 42a-b to be emitted as white light through the extraction edges 45d, 46d.

The person skilled in the art realizes that the present invention by no means is limited to the preferred embodiments described above. On the contrary, many modifications and variations are possible within the scope of the appended claims. For example, combinations of macrostructure and diffuse surfaces may advantageously be used for achieving improved spatial uniformity of emitted light. Furthermore, a larger number and other colors of light-sources than those described above may be used. Especially for general-purpose lighting applications, it may be useful to add a fourth or even a fifth color, such as amber or cyan, which improves the color-rendering index. In addition to the guiding edges, the top and bottom surfaces of the waveguide can also be configured such that the direction of reflection varies with position of incidence of a ray of light impinging on the surface(s) in a given direction of incidence. Furthermore, multiplayer reflectors can be used as reflectors. Such multiplayer reflectors may be designed having a lower absorption than metallic reflectors.

1. A waveguide arranged to guide light from at least one light source, said waveguide comprising:
an outcoupling structure adapted to enable outcoupling of said light from said waveguide in a general outcoupling direction,
at least one guiding edge adapted to contain said light in said waveguide by reflecting said light on its way towards said outcoupling structure, wherein
said outcoupling structure comprises an asymmetrically diffusing layer.

2. A waveguide according to claim 1, wherein said diffusing layer is adapted to diffuse light differently in two different planes parallel to the general outcoupling direction.

3. A waveguide according to claim 1, wherein said waveguide is arranged to guide light from a plurality of light sources, and mix said light in at least one mixing plane.

4. A waveguide according to claim 3, wherein said diffusing layer is adapted to diffuse light more in said mixing plane than in a plane normal to said mixing plane.

5. A waveguide according to claim 1, wherein said diffusing layer is a transparent diffusing layer.

6. A waveguide according to claim 1, wherein said diffusing layer is a diffusing mirror.

7. A waveguide according to claim 1, wherein said waveguide is a planar waveguide.

8. A lighting device comprising at least one light source and a waveguide according to claim 1.

9-11. (canceled)
